(19) United States
(12) Patent Application Publication
(10) Pub. No.: US 2008/0129649 A1
(43) Pub. Date: Jun. 5, 2008

(54) Electronic Display Frame with Coordinated Image

(76) Inventors: Dennis Shelby, Woodland Hills, CA (US); Robin Sturmthal, Woodland Hills, CA (US)

Correspondence Address: FISH & ASSOCIATES, PC;ROBERT D. FISH, 2603 Main Street, Suite 1050, Irvine, CA, 92614-6232, US

(21) Appl. No.: 11/961,591

(22) Filed: Dec. 20, 2007

Related U.S. Application Data
(63) Continuation-in-part of application No. 11/203,560, filed on Aug. 12, 2005.
(60) Provisional application No. 60/649,324, filed on Feb. 1, 2005.

(51) Int. Cl. G09G 5/00

(52) U.S. Cl. 345/1.3

(57) ABSTRACT

A system for decoration of an electronic display generally comprises a border positionable about the display, a first image displayable on the display, and wherein the border carries a design that coordinates with the first image displayable on the display, such that, the border can have a design that: (a) coordinates with the first image by completing at least a part of an object depicted in the first image, (b) completes at least part of a second object within a second image that is displayed subsequently to display of the first image, or (c) is continuous with an object within the first image. It is also contemplated that the first and/or second images are displayed as part of a screen saver or as wallpaper, or delivered to a user as part of a subscription service.

This application is a CIP of U.S. patent application Ser. No. 11/203,560 filed Aug. 12, 2005, which claims the benefit of U.S. provisional application No. 60/649,324 filed on Feb. 1, 2005. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is computer monitor display accessories.

### BACKGROUND OF THE INVENTION

A computer monitor or other electronic display typically has an unadorned border (e.g., computer bezel) surrounding its display screen. It is known to adorn such a border by adhering objects to it, including objects that substantially frame the entire monitor screen.

For example, U.S. Pat. No. 5,549,267 to Armbruster teaches a computer monitor frame having a “sticky notes” type of adhesive layer that supports notes or papers without the use of pins or tacks. U.S. Pat. No. 5,638,096 to Schwartz teaches a display frame with a white board, corkboard or other message holding or writing surface. U.S. Pat. No. 5,564,209 to Zagnoli uses a Velcro™ band to attach a large 3-D display frame to a television.

It is also known to use chambers around the perimeter of an electronic display frame to receive interchangeable image bearing elements. For example, U.S. Pat. No. 6,817,128, and U.S. Pat. No. 6,550,172 to Korpai teach the use of such chambers to receive image bearing strips, decorative three dimensional objects, or appearance changing objects. (See also, U.S. Pat. No. 5,197,213 to Borden, U.S. Pat. No. 5,465,514 to Ulysse, and U.S. Pat. No. 7,114,278 to Marks et al.)

It is also known to use electronic images as a background or a screen saver for an electronic display screen.

However, the decorative features of the display frames of the above examples are all entirely independent of any content displayed on the display screen. Thus, among other things, there is still a need for an electronic display frame that carries a design that coordinates with a screen saver, wallpaper, or other displayed image.

### SUMMARY OF THE INVENTION

The present invention provides apparatus, systems and methods in which a system for decoration of an electronic display comprises a decorative border positionable about the display, and a displayable image that coordinates with the border.

As used herein, the terms “coordinates” and “coordinating” means that the design of the border and the image displayable on the display: (a) form a continuous line (e.g. the outline of an airplane as in FIG. 13C or a ball as in FIGS. 14C, 14D); (b) depicts positionally related subject matter (e.g.; fur or feathers and eyes or an animal as in FIG. 12C); (c) depicts thematically related visual artistry (e.g.; basketball; soccer ball; football; hockey stick; and other sporting equipment); or (d) depicts a design on the border that fully or partially completes an image displayed on the display (e.g., FIGS. 14C, 14D).

By way of further definition, the concept of “coordinating” excludes a border that relates to the image merely by a verbal description (e.g., a title or name of the image as in U.S. Pat. No. 7,114,278), or a decorative geometric border pattern in combination with a sketch or image of a person or other non-geometric object (as in U.S. Pat. No. 5,465,514). Placement of the 3D football and goalposts on top of a television set (as in U.S. Pat. No. 5,564,209) does not comprise a coordinating border and image because the football and goalposts are not part of a border positionable about the display.

Coordinating borders and images are preferably marketed and sold in sets (and possibly with support software), but it is contemplated that coordinating borders and images could be sold individually. The border can be marketed and sold as a single unit, a kit, or as individual or grouped sides or other members (decorative or structural) that compose the border.

It is also contemplated that the border can have an outside edge that is not linear. Such borders could, for example, include a concavity or divot, or the decorative frame could physically extend outward to accommodate an image that goes beyond the bezel or rim of the electronic display. As used herein, the terms “bezel” and “rim” are deemed to be coextensive.

It is still further contemplated that the first and/or second images can be displayed as part of a screen saver or as wallpaper. The images can be delivered in any suitable manner, including, for example, as part of a subscription service.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a front view of a monitor frame on a computer system.

FIG. 2 is an exploded view of a monitor frame.

FIG. 3 is an exploded view showing one corner of a monitor frame.

FIG. 4 is an exploded view showing one corner of a monitor frame where the side members are further apart than shown in FIG. 3.

FIG. 5 is an exploded view showing one corner of the monitor frame where the two side members are not mitered.

FIG. 6 is a view of one embodiment of a monitor frame.

FIG. 7 is a view of one embodiment of a monitor frame.

FIG. 8 is a view of one embodiment of a monitor frame having a pocket.

FIG. 9 is a front view of a monitor display system without face plates where an electronic image shares a theme with the decorative pattern of a monitor frame.

FIG. 10 is a front view of a monitor display system with face plates where an electronic image shares a theme with the decorative pattern of a monitor frame.

FIG. 11 is a front view of a side member having perforations.

FIG. 12A is a front view of a border positionable about an electronic display.

FIG. 12B is a front view of an image displayable on the electronic display, which coordinates with the border of FIG. 12A.

FIG. 12C is a combined front view of the border of FIG. 12A and the image of FIG. 12B.

FIG. 13A is a front view of an alternative border positionable about an electronic display.

FIG. 13B is a front view of an alternative image displayable on the electronic display.

FIG. 13C is a front view of the border of FIG. 13A, coordinating with the image displayed on the electronic display of FIG. 13B, such that the design of the border is continuous with an object within the image.

FIG. 13D is a front view of the border of FIG. 13A having two interconnecting portions.

FIG. 13E is a front view of the border of FIG. 13A having four interconnecting portions.

FIG. 14A is a front view of yet another border positionable about an electronic display.

FIG. 14B is a front view of a first image displayable on the electronic display.

FIG. 14C is a front view of the border of FIG. 14A positioned about an electronic display, having a design that coordinates with the first image displayed on the electronic display of FIG. 14B by completing at least a part of an object depicted in the first image.

FIG. 14D is a front view of the border of FIG. 14A positioned about an electronic display, having a design that completes at least part of a second object within a second image that is displayed subsequently to display of the first image.

FIG. 15A is a front view of still another border positionable about an electronic display.

FIG. 15B is a front view of a coordinating strip along an edge of still another image displayable on the electronic display.

FIG. 15C is a front view of the border of FIG. 15A positioned about an electronic display, coordinating with a coordinating strip of the image displayed on the electronic display of FIG. 15B.

### DETAILED DESCRIPTION

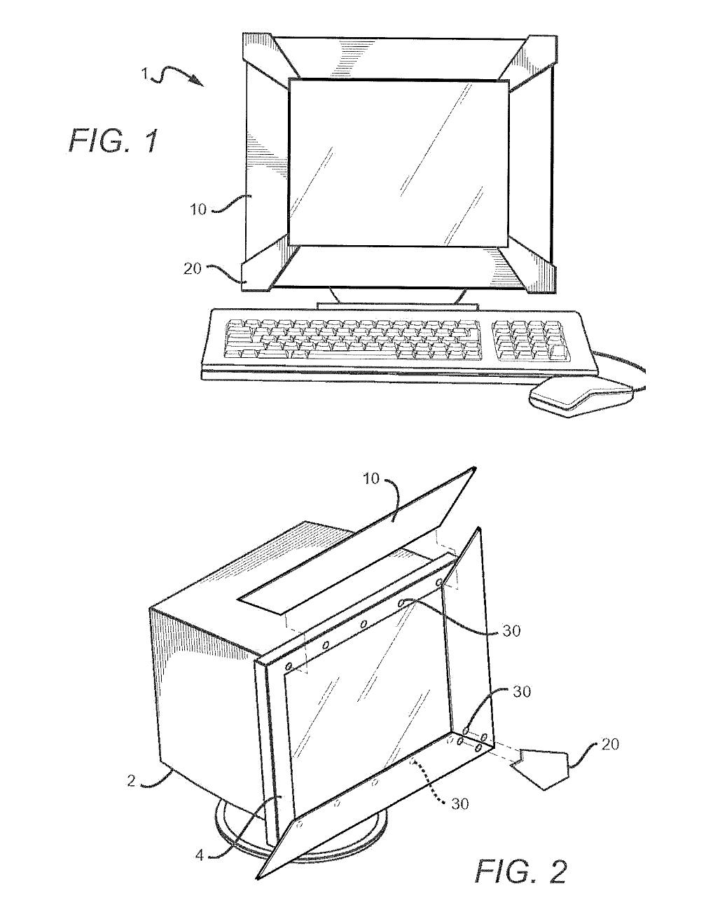

Referring first to FIGS. 1 and 2. A frame 1 has side members 10 and face 20. Side members are attached to the rim 4 of a monitor 2 by using couplings 30. Various known types of couplings can be used, for example, hook-and-loop coupling, and double-sided adhesive tape.

In one aspect of the invention, the side members 10 are attached to rim 4. Therefore rim 4 acts as a coupling device that interconnects and restricts relative movement between the side members.

In FIG. 1, a separate face 20 attaches to side members 10 using couplings 30. Various known types of couplings can be used, for example, hook-and-loop coupling, double-sided adhesive tape.

The face 20 obscures (a) at least a portion of the rim 4 and (b) at least a portion of an end of each of the side members 10 from a view of a user of the computer monitor. As used herein, the term “computer” refers to any general-purpose data processing machine, including especially those running popular operating systems such as DOS, VM and MVS (or IBM™ mainframes), VMS (for DEC machines), UNIX™ (including proprietary variations such as AIX, Ultrix, and UNICOS), Microsoft™ Windows, Microsoft™, OS/2, and Apple™ OS. As used herein, the term “monitor” refers to an electronic display comprising of a device that takes signals from a computer and displays the signal on an electronic screen.

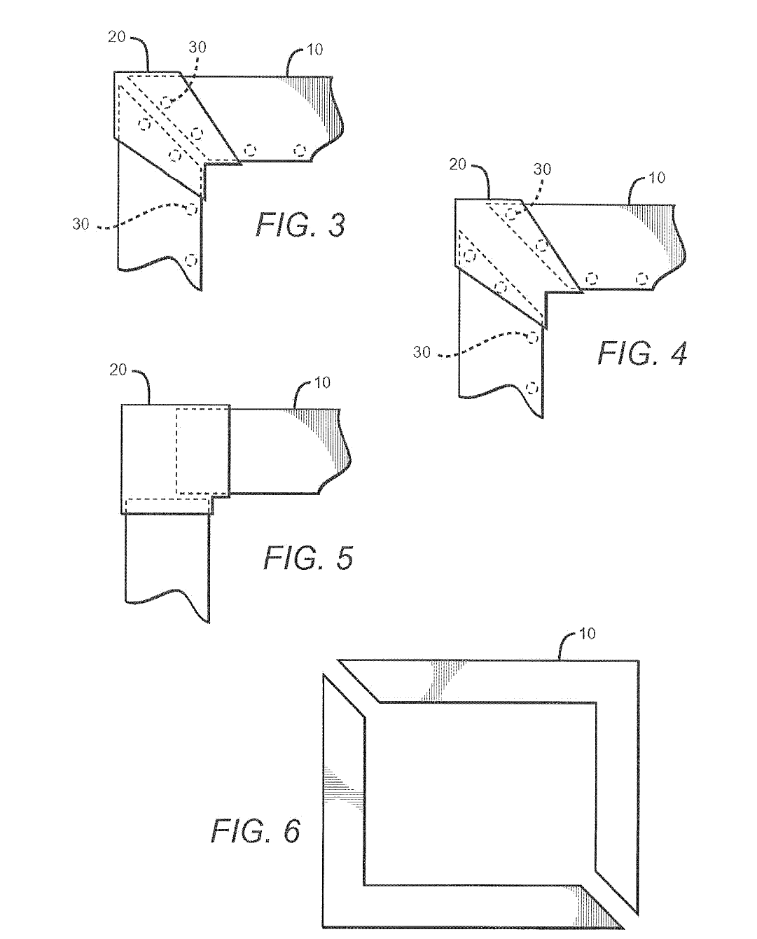

As shown in FIGS. 3 and 4, the face obscures the gap between two adjacent side members 10, and is sized and dimensioned to obscure gaps as wide as 10 cm. This way, a user can arrange the side members 10 such that frame 1 can fit a number of monitor sizes without showing unsightly gaps.

It should be noted that side members 10 do not necessarily miter at its ends. The ends of side members 10 can have different geometric shapes, such as rectangular shape as shown in FIG. 5.

In one embodiment, the face 20 can be inseparable from a side member 10. As such, the face is inseparably attached to a side member 10 and covers the gap between the side member and another side member.

In a preferred embodiment, the side members 10 has a trapezoid shape as shown in FIGS. 1 and 2.

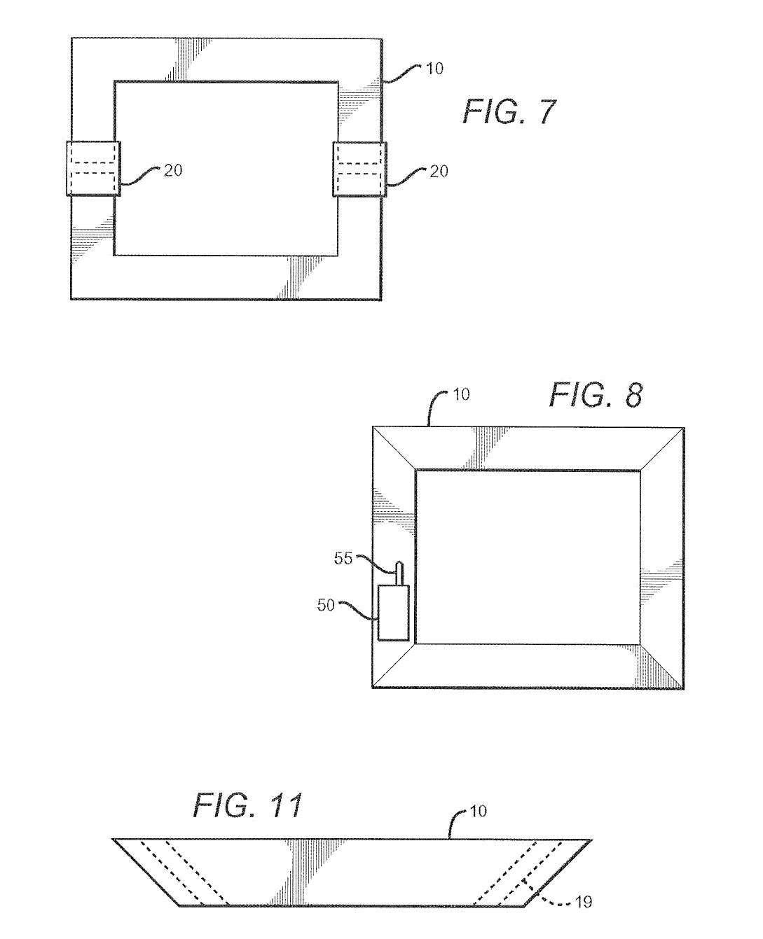

FIG. 6 illustrates one configuration of the side member 10 where each side member is substantially “L” shaped and includes just one corner. FIG. 7 illustrates one configuration of the side members 10 where each side member is substantially “U” shaped and includes two corners.

In further preferred embodiments, the frame has a pocket 50 for holding small items. In FIG. 8, the pocket 50 holds a pencil 55. Other embodiments can have a pocket for holding eye glasses, or the pocket can be a water vial holder for flowers. In another embodiment, clear vinyl pockets are provided on various locations of the device for holding photographs, memos, or other articles. It should be appreciated that the pocket can have various sizes, shapes, and be located at different locations on the side members 10.

One aspect of the current invention includes having decorative covering on side members 10. The type of decorative covering is purely design choice, which may be: a fabric; a printed image; an animal print; a covering with a texture that simulates animal fur; a polymeric covering that simulates a surface of a basketball.

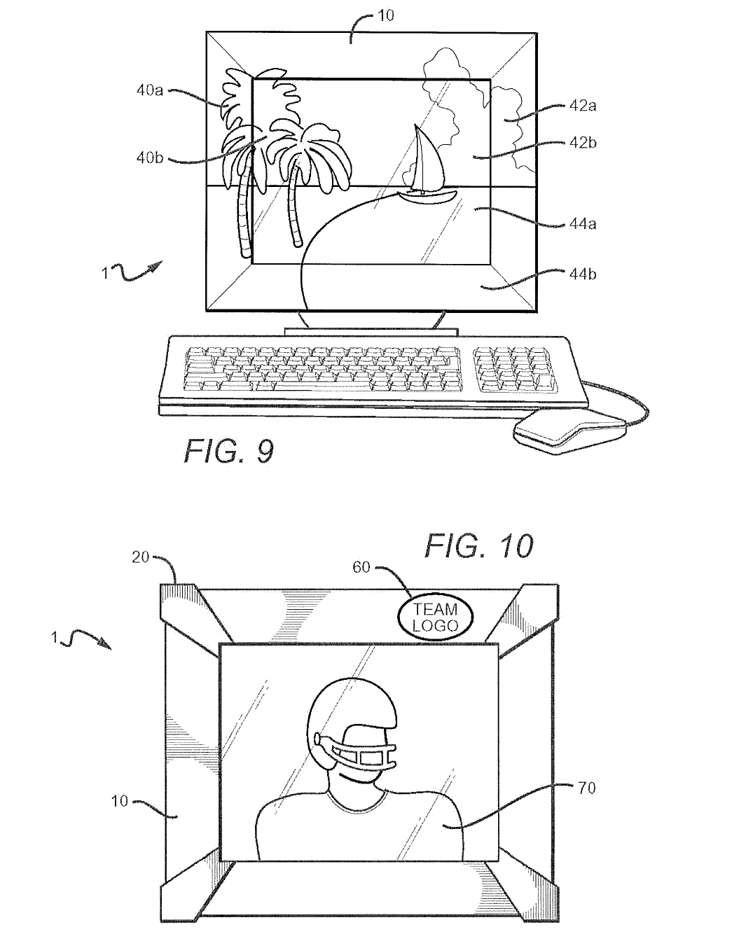

In another aspect of the current invention as illustrated in FIGS. 9 and 10, a monitor display system has a monitor frame 1 and an electronic image display. This electronic image can be a wallpaper or a screen saver, or can be an image file displayed via a computer application.

It is contemplated that the decorative pattern on the frame shares a theme with the electronic image. A multitude of themes maybe implemented, for example: Sports, automobiles, scenic photography, flowers, animals, landscape, travel, people, cartoon characters, sports teams and players (as in FIG. 10), famous celebrities, boating, aviation, movie posters, aquatic life, the beach, images of the space. Using a specific theme is purely design choice and it should be noted that this is only a short list of possible themes.

In FIG. 9, the frame is contemplated to have a pattern that extends into the electronic image. For example, palm trees 40A and 40B, clouds 42A and 42B, water 44A and 44B visually blends into one another.

In FIG. 11, side member 10 has perforations 19 that can be broken out to provide a side member having a desired length. Side member 10 with perforations 19 is preferably made of a rigid substance such as molded plastic or vinyl. Other suitable materials include, for example, fiberglass, cardboard, polymeric material, and so forth. These materials are also suitable for side members 10 without perforations 19.

In addition, side members can have a traditional picture frame design, made from stained foam core or other wooden or light weight synthetic polymer molding. These materials and designs provide a three-dimensional texture and has face 20 that corresponds to the three-dimensional shape of the side members. The face for this embodiment can have a face that resembles a corbel.

Methods of manufacturing the side members 10 and face 20 is as follows: For side members and faces made of fabric, 30 pt. polystyrene can be used as a stiffener. Other preferred materials for stiffener includes chipboard, or other polymeric materials.

Another preferred mode of manufacture is to print desired image to 10 pt paper, laminating it, and then mounting the printed paper on both sides of 20 pt polystyrene followed by die-cutting. Another preferred manufacturing method includes printing directly to a gloss trans vinyl, or trans alloy. Optionally, polyethelene and polystyrene can be used. As for printing process, 4 color process printing and screen printing can be used.

Suitable ways of attaching decorative covering to the side members include sewing. Contemplated side member can also be padded or upholstered with a paper or vinyl backed foam stiffener.

It is contemplated that a bookbinding method can be used to produce side members and faces made of faux metallic coated papers. This method utilizes a Potdevin™ gluer, and involves subsequently gluing the paper to a styrene or chipboard stiffener. Bookbinding can be used for any paper-backed material, including vinyls. A permanent spray mount would also work.

All sizes of frames are contemplated. Preferred frame size is to accommodate computer monitors range from 15″ to 23″ standard size (mostly a 3:4 ratio) as well as the various sized 16:9 ratio monitor that is becoming more popular. Another embodiment of the present invention is to accommodate electronic display screens where the entire rim of the electronic display is made from single injection molding. Other preferred frame sizes are also contemplated to accommodate other electronic devices with electronic displays of various sizes. These general electronic devices includes televisions, cellular phones, PDAs (Personal Digital Assistant), billboards, casino gaming machines, automotive instrument displays, audio-visual equipment displays, close-circuit monitors, and the like.

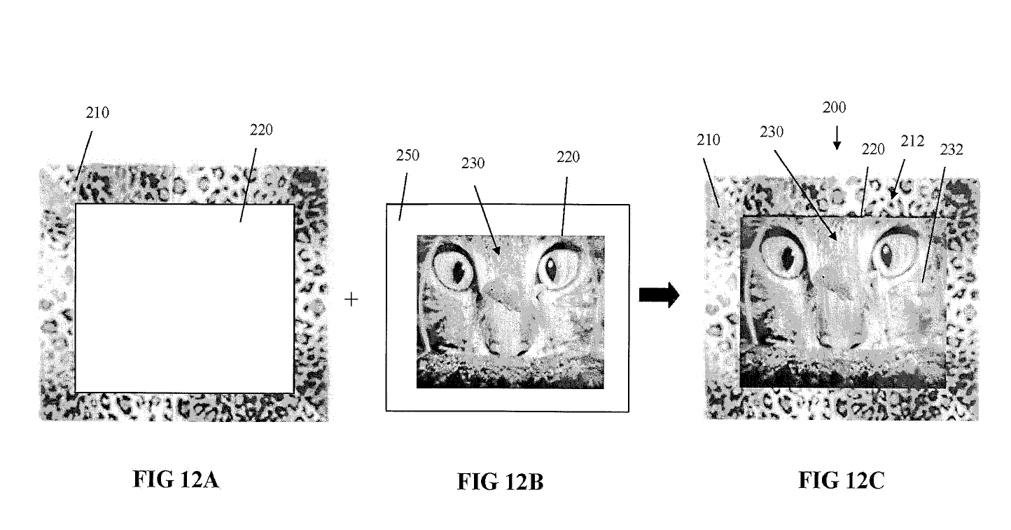

FIGS. 12A-C generally depict an electronic display frame having a border 210, a coordinated image 230, which collectively compose combination 200.

The image 230 is displayed on display 220, and the border 210 has a design 212 that coordinates with an object 232 (e.g., a cat) in image 230, by depicting thematically related visual artistry (e.g., fur and a cat). The image 230 can be any suitable image, including, for example, photographs, geometric or abstract designs, a collage or other arrangement of multiple images, and video clips or other moving images. Contemplated images preferably occupy most or all of the display 220, but could occupy only a subset of the display.

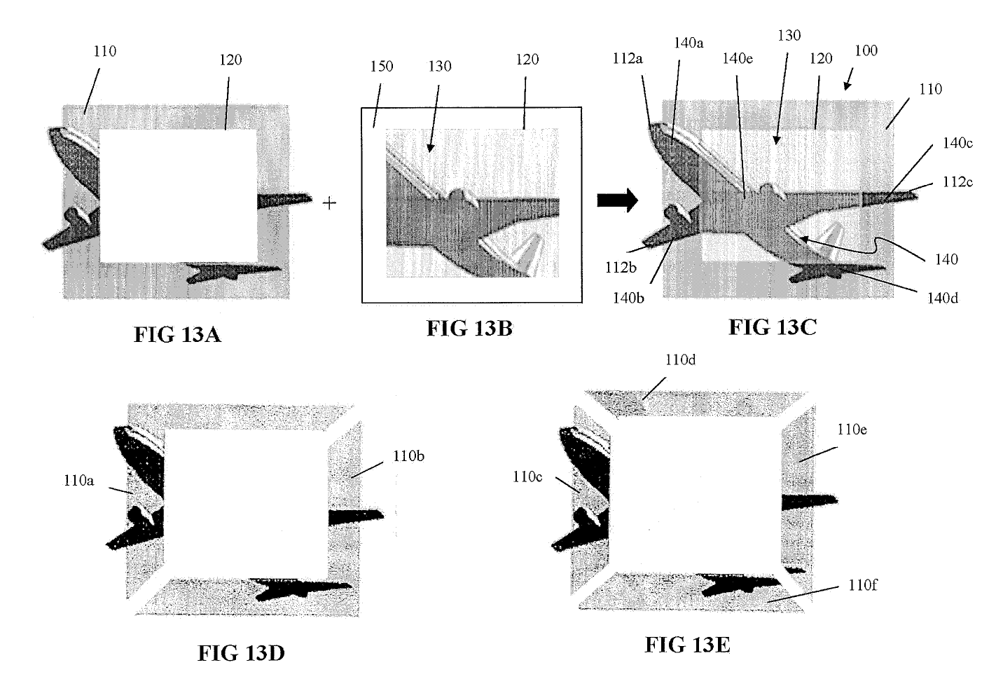

Border 210 is preferably attachable to a bezel or rim 250 of the corresponding display device using a hook and loop, clips, straps, weak adhesive, or other releasable and re-usable connectors. Borders preferably cover the entirety of bezel or rim 250, but could alternatively have cutouts or transparent regions through which the bezel or rim is visible. In yet other alternative embodiments, the border can also extend beyond the outer lines of the bezel or rim (see FIGS. 13A-E).

FIGS. 13A-C depict an alternative embodiment of the electronic display frame having a border 110 positionable about the display 120, and a coordinated image 130 displayable on display 120, which collectively compose combination 100.

Advantageously, image 130 coordinates with border 110, such that a design 140a, 140b, 140c, 140d (e.g., portions of airplane) in border 110 complete an object 140e (e.g., body of airplane) in image 130 to collectively compose an airplane 140 that extends from image 130 to border 110. It is also contemplated that the boundary of border 110 has an outside edge that is non-linear, such that the border is physically extended to accommodate an image that goes beyond the bezel or rim 150, and which is trimmed to conform to extensions 112a, 112b, 112c representing the protruding portions of airplane 140.

Alternatively, as depicted in FIGS. 13D-E it is contemplated that the border 110 of FIGS. 13A-C can comprise either two side members 110a, 110b (see FIG. 13D) or four side members 110c, 110d, 110e, 110f (see FIG. 13E). As discussed above, the border can be sold by itself, or with coordinating images (and possibly support software). The border can also be sold as a single unit, a kit, or as individual or grouped members (here 110a, 110b, 110c, 110d, 110e, 110f) that compose the border 110.

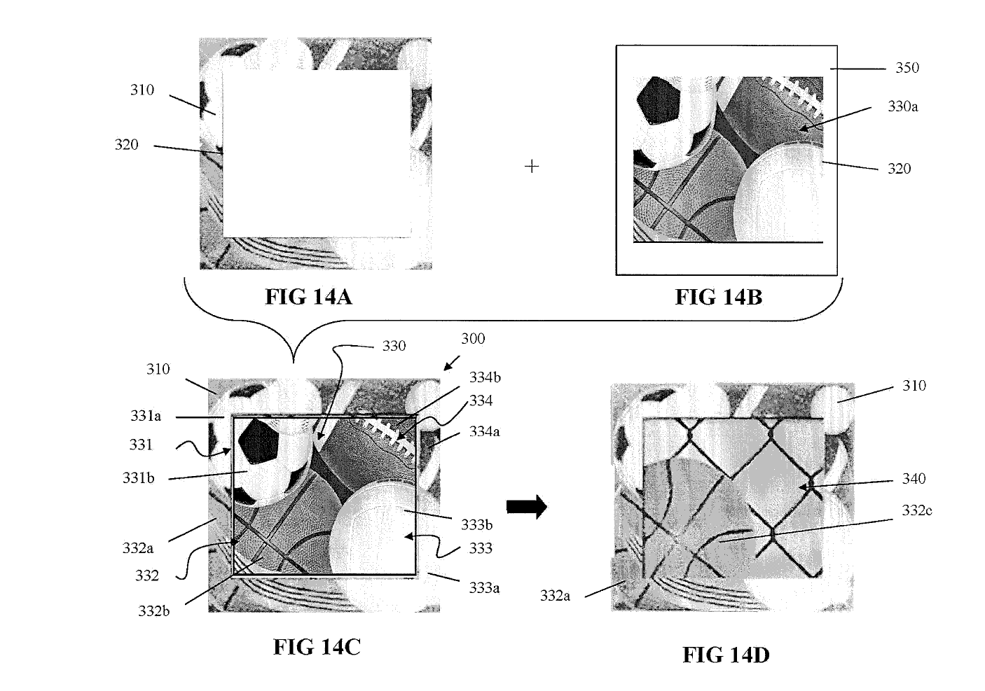

FIGS. 14A-C depict yet another alternative embodiment of the electronic display frame. Here, combination 300 comprises border 310 and image 330 (see FIG. 14C). Border 310 carries designs 331a, 332a, 333a, 334a that coordinates with the first image 330 by completing at least part of an object (331b, 332b, 333b, 334b, respectively) in image 330 to form soccer ball 331, basketball 332, volleyball 333, and football 334, respectively, that collectively extend from image 330 to border 310 (see FIG. 14C).

In FIG. 14D a design 332a (e.g., portion of basketball) of border 310 completes at least part of a second object 332c (e.g., portion of basketball) within a second image 340, to form another basketball that extends from image 340 to border 310. The second image 340 is displayed subsequently to the display of the first image 330.

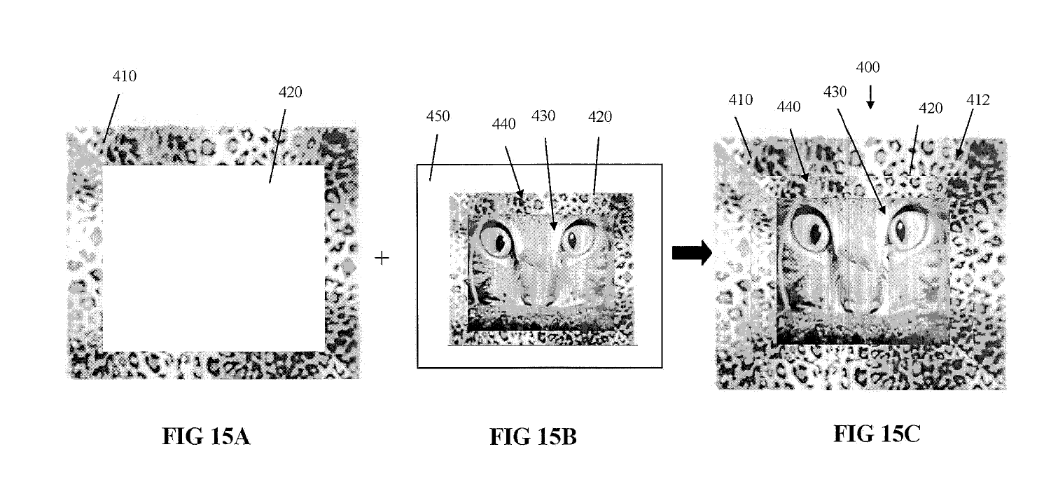

FIGS. 15A-C depict yet another alternative embodiment of the electronic display frame having border 410 and image 430, which collectively compose combination 400. Border 410 carries a design 412 that coordinates with a coordinating strip 440 along an edge of the first image 430, such that design 412, coordinating strip 440, and image 430 depict thematically related visual artistry (e.g., fur and a cat).

Thus, specific embodiments and applications of decorative computer monitor frame have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for decoration of an electronic display, comprising:
a border positionable about the display;
a first image displayable on the display; and
wherein the border carries a design that coordinates with the image.

2. The system of claim 1 wherein the design coordinates with the first image by completing at least a part of an object depicted in the first image.

3. The system of claim 2 wherein the design also completes at least part of a second object within a second image that is displayed subsequently to display of the first image.

4. The system of claim 3 wherein the first and second images are displayed as part of a screen saver.

5. The system of claim 1 wherein the design is continuous with an object within the first image.

6. The system of claim 1 wherein the first image is displayed as wallpaper.

7. The system of claim 1 wherein the first image is displayed as a screen saver.

8. The system of claim 1 wherein the border has an outside edge that is not linear.

9. The system of claim 1 further comprising a coordinating strip along an edge of the first image.

10. The system of claim 1 wherein the image is delivered to a user as part of a subscription service.

11. An article of manufacture, comprising a package having an incomplete set of the border elements of claim 1.
